(19) United States
(12) Patent Application Publication
(10) Pub. No.: US 2005/0092188 A1
(43) Pub. Date: May 5, 2005

(54) Cooking grill

(75) Inventors: Michael L. Huegerich, St. Louis, MO (US); Thomas Vaughn, Ballwin, MO (US); Frank Ricchio, Wildwood, MO (US); Tim Gaskill, Edwardsville, IL (US)

Correspondence Address: HUSCH & EPPENBERGER, LLC, 190 CARONDELET PLAZA, SUITE 600, ST. LOUIS, MO, 63105-3441, US

(73) Assignee: Star Manufacturing International, Inc., St. Louis, MO (US)

(21) Appl. No.: 10/966,053

(22) Filed: Oct. 15, 2004

Related U.S. Application Data
(60) Provisional application No. 60/511,978, filed on Oct. 16, 2003.

(51) Int. Cl. A47J 37/00

(52) U.S. Cl. 99/421 R; 126/41 B; 126/41 R

(57) ABSTRACT

An improved cooking grill includes a base; a grilling area with a heat source; a control panel; an integrated rotisserie with a rotating spit located adjacent the grilling area driven via a coupling by a motor located within the base; a temperature probe located adjacent the grilling area; and a removable control module communicating with the temperature probe and having a grill light, a timer, a temperature display, and a handheld food probe.

### CROSS-REFERENCES

This application claims the priority of provisional application Ser. No. 60/511,978, filed Oct. 16, 2003.

### TECHNICAL FIELD OF THE INVENTION

The present invention relates generally to devices for preparing, storing, and serving food and, more particularly, to an improved cooking grill.

### BACKGROUND OF THE INVENTION

High-end outdoor barbeque grills represent an important portion of the residential cookware market. Grills in this market segment are feature laden. One of the features common to most high-end grills is a rotisserie cooker. This consists of a drive motor in a metal housing that is mechanically attached to the outside of the grill. This motor drives a removable spit rod that holds the food product being cooked. In many cases, there is a dedicated gas infrared burner parallel with the spit rod that cooks the turning product.

One of the drawbacks with this arrangement is the inconvenience arising out of the need to attach the motor housing assembly to the grill before cooking, and to remove the motor from the grill after cooking. A power cord leading from the motor housing must be plugged in at the time of cooking to power the drive motor. If the motor is left in place, it is exposed to adverse weather, thus decreasing its useful life. Also, having the motor connected to the outside of the grill becomes unsightly in a market that spends a tremendous amount of effort on aesthetics.

Many grills in the industry offer a hood mounted dial thermometer to help the user determine the temperature inside the grill. These thermometers are not very accurate, and at best give the user a general idea of the grill's temperature. Using the grill to slow cook foods at lower temperatures becomes difficult when trying to judge cooking temperature with the dial thermometer. Another problem with the dial thermometer is that it only shows the temperature of the grill area, and gives the user no information as to the temperature of the food being cooked. This becomes a problem with trying to determine the doneness of food products that require being heated to a specific temperature.

The present invention is directed to overcoming one or more of the problems set forth above.

### SUMMARY OF THE INVENTION

An aspect of the present invention is to provide a cooking grill with enhanced convenience, control, and storage capabilities.

In accordance with the above aspects of the invention, there is provided a cooking grill including a base; a grilling area with a heat source; a control panel; an integrated rotisserie with a rotating spit located adjacent the grilling area and driven via a coupling by a motor located within the base; a temperature probe located adjacent the grilling area; and a removable control module communicating with the temperature probe and having a grill light, a timer, a temperature display, and a handheld food probe.

This aspect is merely illustrative of the various aspects associated with the present invention and should not be deemed as limiting in any manner. This and other aspects, features and advantages of the present invention will become apparent from the following detailed description when taken in conjunction with the referenced drawings.

### BRIEF DESCRIPTION OF THE DRAWINGS

Reference is now made to the drawings which illustrate the best known mode of carrying out the invention and wherein the same reference numerals indicate the same or similar parts throughout the several views.

FIG. 1 is a front view of an improved cooking grill according to one embodiment of the present invention.

FIG. 2 is a side view of an integrated rotisserie mechanism incorporated into an improved cooking grill according to another embodiment.

FIG. 3 is an angled view of a computer module for an improved cooking grill according to yet another embodiment.

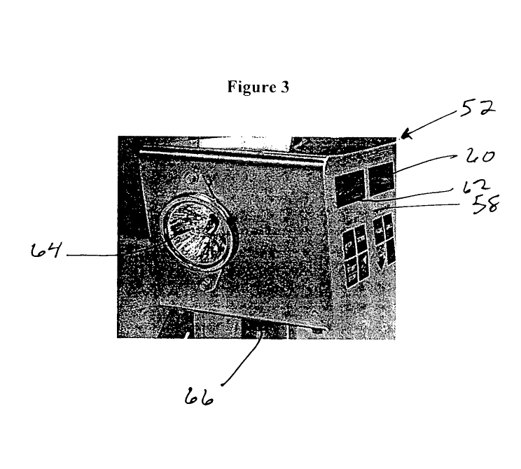

FIG. 4 is a front view of the computer module control panel of FIG. 3.

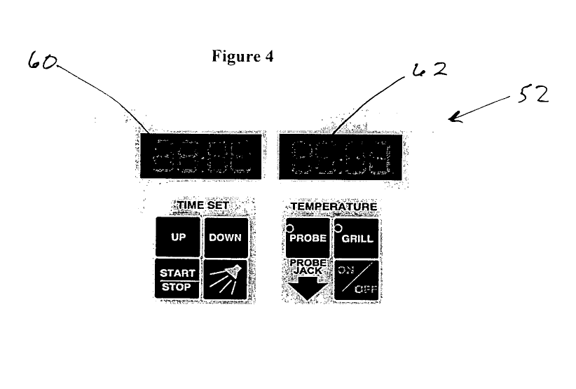

FIG. 5 is a side view of a connector for the computer module of FIG. 3.

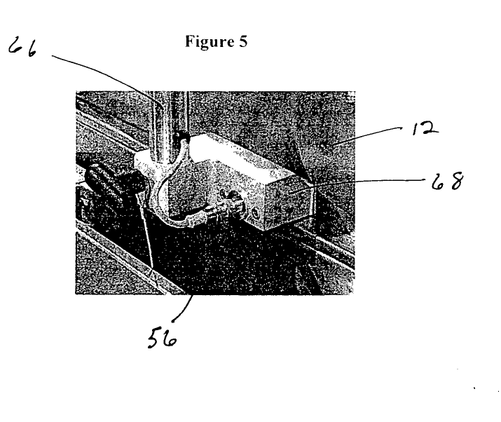

FIG. 6 is a front view of an improved cooking grill according to another embodiment.

FIG. 7A is perspective view of a motor compartment and baffling system for an improved cooking grill with one baffle removed to reveal the motor.

FIG. 7B is a perspective view of the motor compartment of FIG. 7A with the baffles in place.

### DETAILED DESCRIPTION

In the following detailed description, numerous specific details are set forth in order to provide a thorough understanding of the invention. However, it will be understood by those skilled in the art that the present invention may be practiced without these specific details. For example, well-known methods, procedures, and components have not been described in detail so as not to obscure the present invention.

An improved gas grill 10 includes a base 12. In a preferred embodiment, the base 12 is generally rectangular in shape and includes a plurality of drawers 14 and doors 16 across its front side. The doors 16 open for access to general storage spaces for cooking utensils and other items. One of the doors 16 opens to an area capable of housing a propane storage tank. The drawers 14 include a frame that accepts a standard commercial food pan. In one embodiment, the food pans are 12″×20″×6″ deep, and can be used for storing utensils or food. These drawers 14 allow a user to prepare food on the grill and transfer it to the removable pan for serving. Since these pans are designed to hold food, their design makes them easily cleaned and sanitary. In a preferred embodiment, the base 12 is constructed from stainless steel for weather-resistance. The base 12 is advantageously wired for electricity.

In an alternate embodiment, the grill 10 is installed into a permanent island or counter. In this embodiment, the grilling area 18, control panel 32, hood 36, and integrated rotisserie 42 (discussed in more detail below) are mounted as a unit into the island.

The base 12 supports a grilling area 18. The grilling area 18 includes a large central recess 20. In embodiments of the grill using gas, the central recess 20 houses at least one gas burner 22 and an igniter 24. In embodiments of the grill relying on charcoal for heat, the central recess 20 includes a slotted lower grate to support the charcoal. A cooking grate 26 spans the top of the central recess 20. In another embodiment, the grilling area 18 also includes a side burner 28 separated from the other burners by a divider 30. The side burner 28 is also covered by a cooking grate.

A control panel 32 is mounted on the front of the base 12 near the top. The control panel 32 includes a plurality of control knobs 34 for operation of the grill. The control panel 32 includes one gas flow control knob for each gas burner, including the side burner. Each knob controls the flow of gas to a burner via a flow control valve associated with the burner, thereby controlling the level of flame and the amount of heat produced by the burner. The use of separate control knobs for each burner allows a user to create separate cooking zones with different temperatures on the grilling surface. There is also a control knob to operate the igniter.

A hinged hood 36 covers the grilling area 18. The hood 36 is pivotably connected by a hinge 38 to the rear of the base 12. A stop limits the range of travel of the hood. The front of the hood 36 is provided with a handle 38 that is advantageously insulated from the hood 36 to prevent the handle 38 from getting excessively hot and potentially injuring a user. When in the closed position, the hood 36 covers the entire grilling area 18 except for the side burner. Side shelves 40 are attached to the base 12 on either side of the grilling area 18. In a preferred embodiment, the front of the hood 36 and the side shelves 40 are arranged with a concave radius for visual distinction. The top of the hood 36 has a convex radius. Side walls 76 are provided on either side of the grilling area 18. The side walls 76 extend from the back to the front of the grilling area 18. The side walls 76 act to help a user corral food while cooking and to minimize grease splatter onto the surfaces surrounding the grilling area 18, simplifying cleaning of the grill.

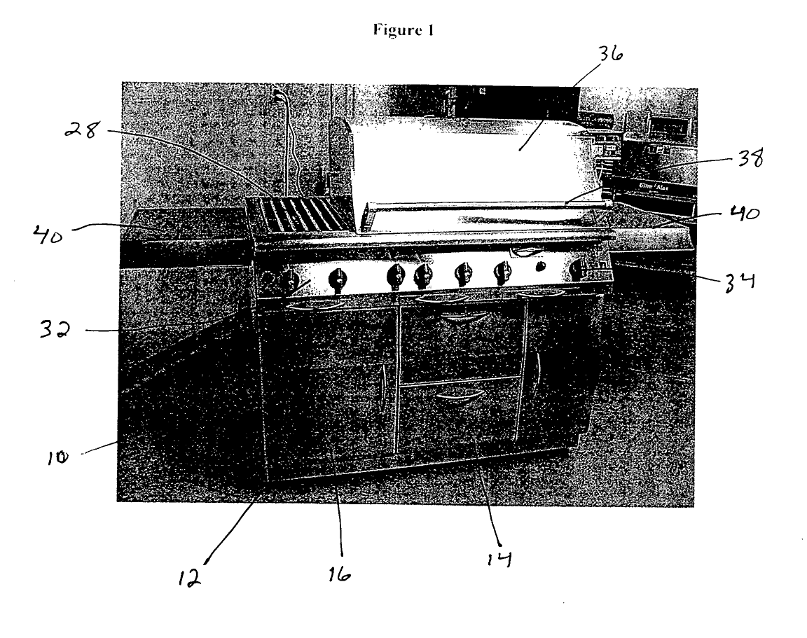

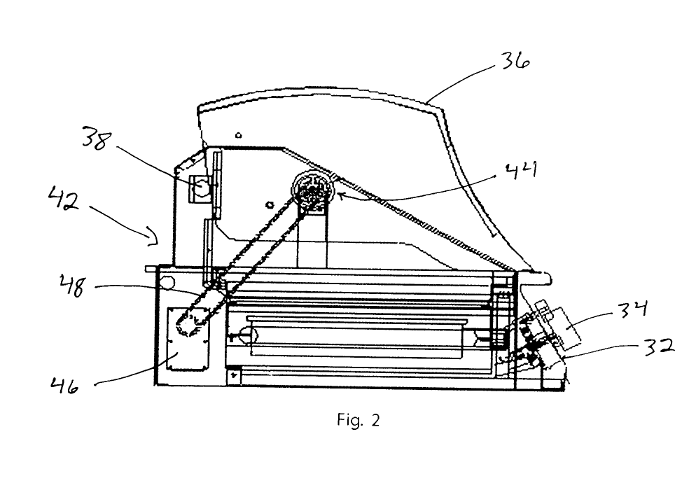

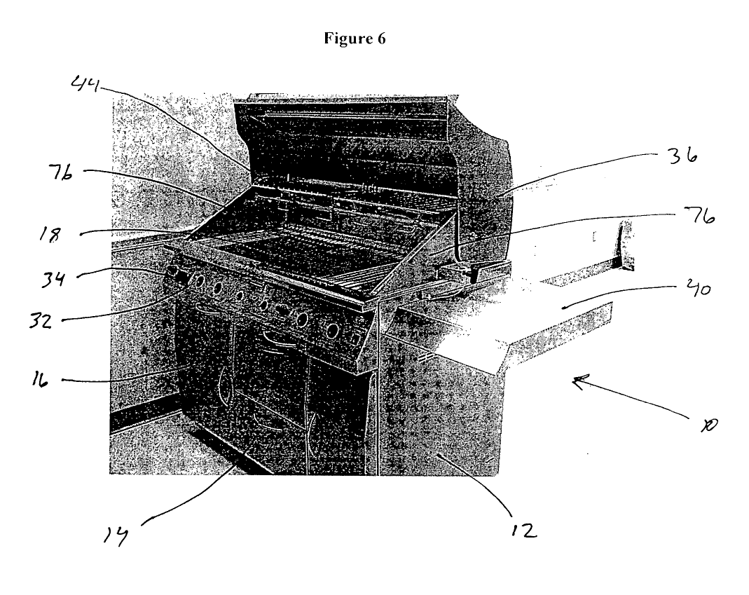

The grilling area 18 is provided with an integrated rotisserie 42. The rotisserie 42 includes a rotating spit 44 that is driven by a motor 46 housed within the base 12 of the grill. A chain 48 transfers motive force from the motor 46 to the spit 44. In alternate embodiments, the transfer of motive force from the motor 46 to the spit 44 is accomplished by a belt drive, by a series of interconnected gears associated with the motor and spit, or by connecting the motor 46 directly to the spit 44. In a preferred embodiment, the coupling 48 between the motor 46 and spit 44 is also enclosed within the base 12 or extension thereof to insulate the coupling 48 from inclement weather and reduce necessary maintenance for the coupling 48. In the embodiment shown in FIGS. 1, 2 and 6, the coupling is enclosed with a triangular extension 13 of the housing 12. A matching triangular plate may be added to the opposite side of the grill to maintain the symmetrical appearance of the grill. The triangular extensions also serve to enhance heat retention of the grilling area 18. An on/off switch for the motor is located remotely from the motor in the control panel 32. In an alternate embodiment, the motor 46 is also provided with a speed control to vary the rotational speed of the spit 44. In this embodiment, a control knob for the speed control is also located in the control panel 32. In a preferred embodiment, the motor 46 is powered directly from the electrical wiring incorporated into the base 12. In alternate embodiments, the grill is powered from a standard extension cord leading to any convenient electrical outlet. The integrated design of the rotisserie 42 eliminates the need to assemble and disassemble the rotisserie and to locate a suitable outlet to power the motor.

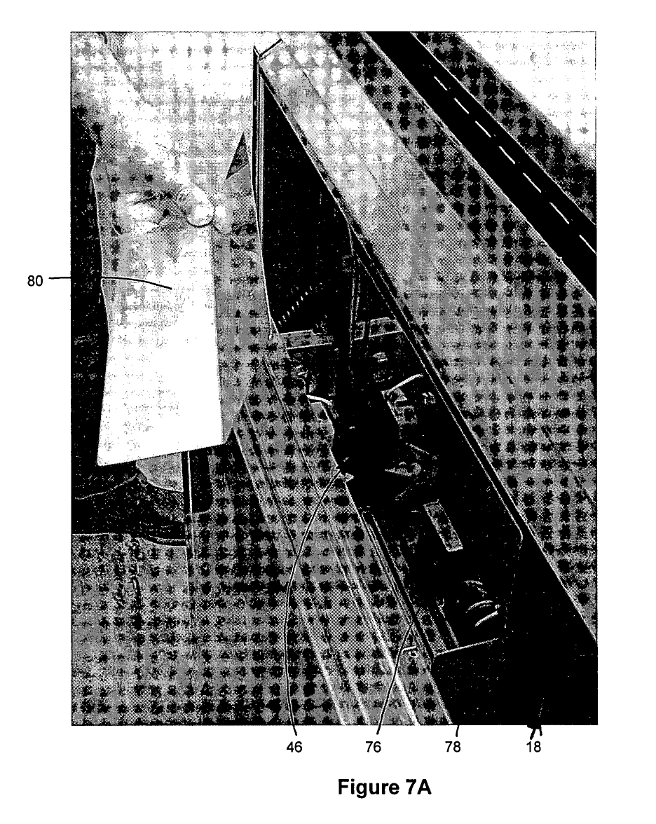

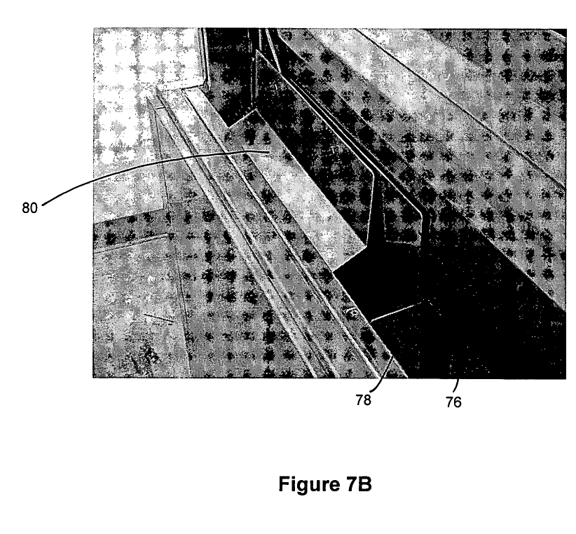

As shown in FIGS. 7A and 7B, a series of shields and baffling 50 isolate the motor 46 and protect it from weather and the heat of the grill. In the preferred embodiment, there are two baffles around the motor 46. An inner baffle 76 provides a barrier between the motor 46 and the grilling area 18. The inner baffle 76 is provided with a flange 78 to partially enclose the motor 46. Advantageously, the inner baffle is spaced away from the grilling area 18 to facilitate air flow around the inner baffle 76. A second baffle 80 is positioned over the motor 46 to provide protection from weather and debris. Advantageously, the second baffle 80 is spaced slightly from the inner baffle 76 to reduce heat transfer and to enhance air flow between the baffles.

Additional control functions for the grill are provided in a separate, removable computer module 52 housed within a stainless steel enclosure for weather-resistance. The computer module 52 is removable for storage, and connects to the grill with a water-proof electrical connector 56. The enclosure contains an electronic control panel 58 with two LED readouts 60, 62. One readout 60 is for time, and the other 62 is for temperature. The module 52 also contains a light 64 to illuminate the grill surface and work area. The computer module 52 is connected to a mounting post 66. The mounting post 66 is arranged to mate with a mounting block 68 on the base 12 of the grill and is secured to the block 68 by a removable pin. The computer module 52 can either be powered internally or from an electrical power source within the base of the grill. In the latter case, electrical power is supplied to the computer module through the electrical connecter 56. In an alternate embodiment, the computer module is permanently integrated into the grill control panel 32.

The temperature display 62 has the ability to show both a grill temperature and a food probe temperature. The grill temperature system uses a temperature probe 70 mounted on the interior of the grill compartment. The sensor 70 is encapsulated in a stainless steel housing to protect it from grease, smoke, and moisture. The control board reads the probe temperature 70, and displays it on the LED readout 62. The temperature measuring is done electronically and has a 1° F. resolution. The food probe feature consists of a handheld insertion 72 probe that plugs into the control module 52. When the probe 72 is plugged in, the handheld probe temperature is displayed in the readout 62. This probe 72 can be inserted into the food being grilled to determine if it has reached the desired internal temperature.

The control module 52 also contains a countdown/count-up timer 74. This feature is beneficial to the user when preheating the grill and when cooking items that require a precise amount of cooking time. When the countdown timer reaches 00:00, an alarm beeps, thereby alerting the user.

Other objects, features and advantages of the present invention will be apparent to those skilled in the art. While preferred embodiments of the present invention have been illustrated and described, this has been by way of illustration and the invention should not be limited except as required by the scope of the appended claims and their equivalents.

1. A cooking grill suitable for outdoor use, comprising:
a housing generally enclosing;
a grilling surface;
a heat source;
a rotisserie spit located adjacent said grilling surface;
a motor located within said housing; and
a coupling to transmit motive force from the motor to the rotisserie spit, wherein said coupling is located at least partially within said housing.

2. The cooking grill of claim 1, wherein said coupling comprises a chain drive located between said rotisserie spit and said motor.

3. The cooking grill of claim 1, wherein said coupling comprises a belt drive located between said rotisserie spit and said motor.

4. The cooking grill of claim 1, wherein said coupling comprises a series of gears located between said rotisserie spit and said motor.

5. The cooking grill of claim 1, wherein said coupling comprises a direct connection between said rotisserie spit and said motor.

6. The cooking grill of claim 1, further comprising a grill control panel incorporated in said housing and a power switch communicating with said motor and incorporated into said control panel.

7. The cooking grill of claim 6, further comprising a speed control switch communicating with said motor and incorporated into said control panel.

8. The cooking grill of claim 1, further comprising an electrical power source within said housing providing electrical power to said motor.

9. The cooking grill of claim 1, further comprising at least a first baffle between said motor and said heat source.

10. The cooking grill of claim 9, further comprising a second baffle positioned adjacent said first baffle and over said motor.

11. The cooking grill of claim 10, further comprising a spacer slightly separating said first baffle and said second baffle from one another.

12. An electronic control pod for a cooking grill, comprising:
a housing;
a computer module enclosed within said housing;
a control panel in communication with said computer module; and
a base connecting said housing with said cooking grill.

13. The electronic control pod of claim 12, wherein said control panel comprises a first electronic readout to display a temperature measurement, a second electronic readout to display time, a temperature measurement control, and a timer control.

14. The electronic control pod of claim 12, further comprising a grill light enclosed within said housing and a light switch associated with said control panel.

15. The electronic control pod of claim 12, wherein said base includes a removable connector to enable connection and disconnection of said base from said cooking grill.

16. The electronic control pod of claim 13, wherein said cooking grill includes a grilling surface and further comprising a fixed temperature probe adjacent said grilling surface and communicating with said control module.

17. The electronic control pod of claim 16, further comprising a stainless steel housing encapsulating said fixed temperature probe.

18. The electronic control pod of claim 13, further comprising a food probe communicating with and detachably connected with the control module.

19. A cooking grill suitable for outdoor use, comprising:
a first housing generally enclosing;
a grilling surface; and
a heat source;
a rotisserie spit located adjacent said grilling surface;
a motor located within said first housing;
a coupling to transmit motive force from the motor to the rotisserie spit, wherein said coupling is located at least partially within said first housing;
a second housing;
a computer module enclosed within said second housing;
a control panel in communication with said computer module; and
a base connecting said second housing with said first housing.
